(19) United States
(12) Patent Application Publication
(10) Pub. No.: US 2010/0122223 A1
(43) Pub. Date: May 13, 2010

(54) Techniques for Computing Capacitances in a Medium With Three-Dimensional Conformal Dielectrics

(75) Inventors: Ibrahim M. Elfadel, Cortlandt Manor, NY (US); Tarek A. El-Moselhy, Cambridge, MA (US)

Correspondence Address: MICHAEL J. CHANG, LLC, 84 SUMMIT AVENUE, MILFORD, CT, 06460, US

(73) Assignee: International Business Machines Corporation, Armonk, NY (US)

(21) Appl. No.: 12/267,599

(22) Filed: Nov. 9, 2008

(51) Int. Cl. G06F 17/50

(52) U.S. Cl. 716/4

(57) ABSTRACT

Techniques for capacitance extraction from an integrated circuit design are provided. In one aspect, a method for determining coupling capacitance between conductors within an integrated circuit design is provided comprising the following steps. A three-dimensional representation of the integrated circuit design is generated based on three-dimensional technology and three-dimensional geometric input about the integrated circuit. Conductors of interest are selected from the design. Three-dimensional coupling capacitance between the selected conductors is determined. Further, a first and a second conductor can be selected from the conductors of interest. A Gaussian surface can be created around the first conductor. A random walk path can be created starting at a randomly selected point on the Gaussian surface and terminating on the second conductor. The random walk path can be used to compute the three-dimensional coupling capacitance between the first and second conductors, which can be separated from one another by multilayered dielectric media.

### FIELD OF THE INVENTION

The present invention relates to integrated circuit design, and more particularly, to techniques for capacitance extraction from an integrated circuit design.

### BACKGROUND OF THE INVENTION

Fast and efficient capacitance extraction is the cornerstone of integrated circuit electrical evaluation. For the past decade, a number of different approaches have been proposed to analyze capacitance. These approaches can be divided into two categories, one category including deterministic techniques, such as boundary element or finite difference methods, and the other category including stochastic techniques, such as floating random walk. In general, deterministic techniques involve solving linear system functions. However, for large integrated circuit geometries, the time needed to obtain the linear system solutions dominates the computational complexity. Different acceleration tools (“fast-solvers”), such as pre-corrected fast Fourier transform, multipole expansion and hierarchical techniques, have been proposed to speed up the system solves.

FIG. 1 is a cross-sectional diagram illustrating parasitic capacitance associated with a wiring structure. In FIG. 1 four conductors (i.e., wires in the wiring structure) are shown, namely conductor 102, conductor 104, conductor 106 and conductor 108. With such a configuration, it is likely that parasitic capacitance (PC) would be created, for example, between conductors 102 and 106 (PC1), between conductors 106 and 108 (PC2) (and similarly between conductors 102/104 and 104/108 (not shown)) and between conductors 102 and 108 (PC3).

The accuracy requirements of wire and device models, as well as macro and chip timing, noise, signal integrity and power verifications are such that very accurate capacitance values are needed for all conducting shapes be they part of wiring structures or semiconductor devices. The latter case is becoming all the more challenging due to the complex dielectric environment in which conducting shapes that are part of devices are embedded. Another challenging aspect of the device case is due to the manufacturing irregularities that are often encountered (see FIG. 2, described below).

FIG. 2 is image 200 illustrating wafer contours present in an active area of a static random access memory (SRAM) cell designed in a 45 nanometer (nm) technology. The highly irregular contours shown in image 200 are present despite the use of lithographic improvement techniques such as optical pre-correction and resolution enhancement. While contour-aware extraction has been proposed to improve the accuracy of layout parasitics in the presence of lithographic irregularities, the highly irregular nature of these contours makes such an approach very time consuming.

Lithography mainly impacts the layout shapes in mask planes. Chemical-mechanical polishing (CMP), on the other hand, contributes to uncertainties in interconnect heights perpendicular to the mask planes. One aspect that is often overlooked is that these shape uncertainties are also accompanied by uncertainties in the dielectric context of the layout shapes. A case in point is the dielectric damage that sometimes results from metallization processes in semiconductor manufacturing. This damage presents itself in three-dimensional dielectric shapes that are conformal to the conducting shapes. There is therefore a need for accurate, fast capacitance calculation techniques that can deal with irregular conducting shapes embedded in three-dimensional conformal dielectric media and potentially containing multiple dielectrics.

The floating random walk is a technique that is known to work with irregular shapes (such as QuickCap® available from Magma Design Automation, Inc., San Jose, Calif.). The floating random walk technique is described, for example, in U.S. Patent Application No. 2006/0053394, filed by Batterywala et al., entitled “Method and Apparatus for Estimating Parasitic Capacitance” (hereinafter “Batterywala”). Batterywala highlights that multiple dielectric layers are typically present between conductors in an integrated circuit layout. Batterywala proposes using pre-computed Green's finctions from an archive to calculate electric field values. Specifically, a square is constructed around a given location, such that a dielectric composition of the square corresponds to a dielectric configuration for which an electric-field Green's function is available in the pre-computed set of Green's functions. The teachings of Batterywala are however limited to two-dimensional applications with horizontally stacked dielectric layers (such as wiring layers) and further to those dielectric configurations for which a pre-computed set of Green's functions exist. As such, the teachings of Batterywala are limited to a small number of dielectrics as pre-computation and tabulation of all possible Green's functions necessary to complete the random walk is required.

Therefore, fast capacitance extraction techniques that can accommodate three-dimensional conducting shapes that are embedded in conformal three-dimensional dielectric medium with multiple dielectrics would be desirable.

### SUMMARY OF THE INVETNION

The present invention provides techniques for capacitance extraction from an integrated circuit design. In one aspect of the invention, a method for determining coupling capacitance between conductors within an integrated circuit design is provided. The method comprises the following steps. A three-dimensional representation of the integrated circuit design is generated based on three-dimensional technology input and three-dimensional geometric input about the integrated circuit. Conductors of interest are selected from the design. Three-dimensional coupling capacitance between the selected conductors is determined.

Further, a first conductor and a second conductor can be selected from the conductors of interest. A Gaussian surface can be created around the first conductor. A random walk path can be created starting at a randomly selected point on the Gaussian surface and terminating on the second conductor. The random walk path can be used to compute the three-dimensional coupling capacitance between the first and second conductors.

The first conductor and the second conductor can be separated from one another by dielectric media at least a portion of which is multilayered. A maximal bounding cube can be constructed to contain the randomly selected point on the Gaussian surface and to extend to the edge of the nearest conductor, the maximal bounding cube including at least a portion of the dielectric media. A Green's function can be obtained for a configuration of the dielectric media within the bounding cube. The random walk path can be ended if the bounding cube is touching the second conductor. Otherwise, a series of maximal bounding cubes can be created, each of which contains a randomly selected point on a boundary of an immediately preceding bounding cube in the series and extends to an edge of the nearest conductor, each maximal bounding cube including at least a portion of the dielectric media. A Green's function can be obtained for a configuration of the dielectric media within each of the bounding cubes in the series. The random walk path can be ended when a bounding cubes in the series is created that touches the second conductor.

A more complete understanding of the present invention, as well as further features and advantages of the present invention, will be obtained by reference to the following detailed description and drawings.

### BRIEF DESCRIPTION OF THE DRAWINGS

FIG. 1 is a cross-sectional diagram illustrating parasitic capacitance associated with a wiring structure;

FIG. 2 is an image illustrating wafer contours present in an active area of a static random access memory (SRAM) cell;

FIG. 3 is a cross-sectional diagram illustrating an integrated circuit design according to an embodiment of the present invention;

FIG. 4 is a diagram illustrating an exemplary methodology for determining capacitance between conductors in an integrated circuit design according to an embodiment of the present invention;

FIG. 5 is a diagram illustrating an exemplary methodology for using a floating random walk technique to determine the capacitance between two conductors according to an embodiment of the present invention;

FIG. 6 is a diagram illustrating an exemplary random walk path according to an embodiment of the present invention;

FIG. 7 is a diagram illustrating an exemplary methodology for using a floating random walk technique to determine capacitance between two conductors separated by arbitrary multilayered dielectric media according to an embodiment of the present invention;

FIG. 8 is a diagram illustrating an exemplary floating random walk path between conductors separated by arbitrary multilayered dielectric media according to an embodiment of the present invention;

FIG. 9 is a diagram illustrating pre-computed transition cubes in a multilayered dielectric media according to an embodiment of the present invention;

FIG. 10 is a graph illustrating a sample Green's function computed for a portion of an exemplary dielectric stack according to an embodiment of the present invention; and

FIG. 11 is diagram illustrating an exemplary system for determining coupling capacitance between conductors within an integrated circuit design according to an embodiment of the present invention.

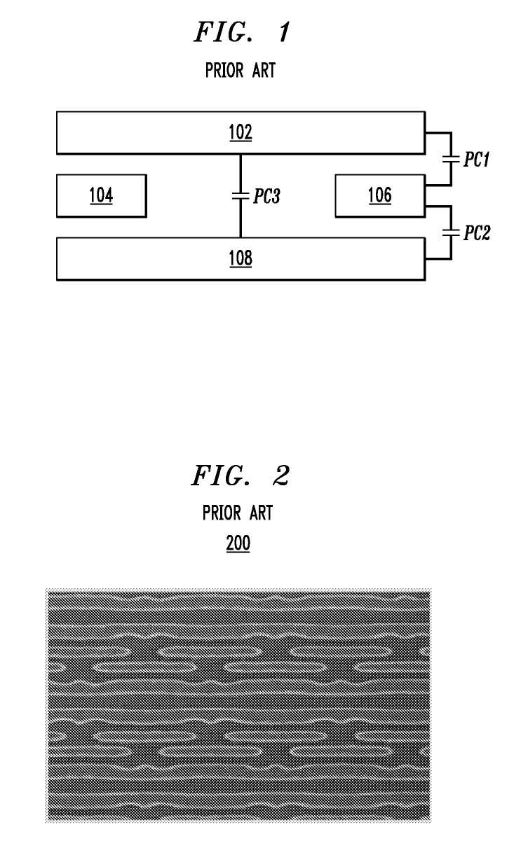

### DETAILED DESCRIPTION OF PREFERRED EMBODIMENTS

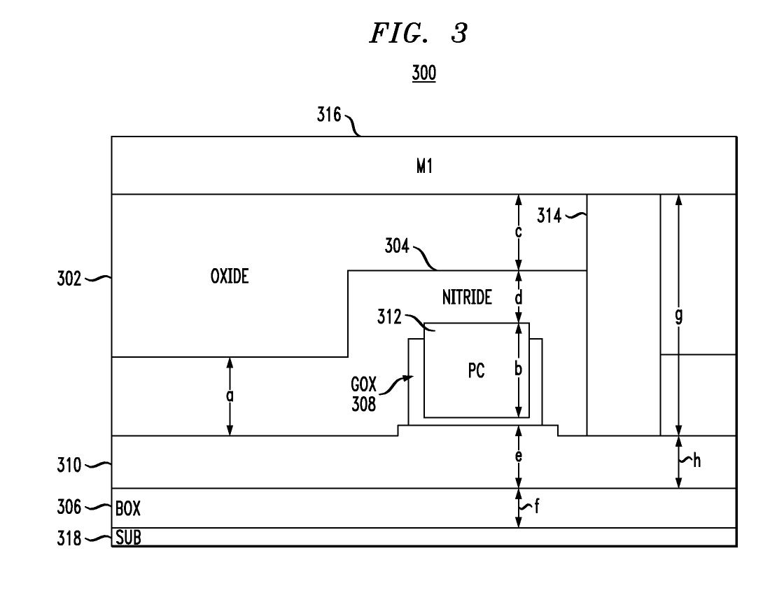

As highlighted above, conformal three-dimensional dielectric media with multiple dielectrics makes capacitance extraction of a given design challenging. FIG. 3 is a cross-sectional diagram illustrating exemplary integrated circuit design 300. FIG. 3 highlights an arbitrary, multilayered media configuration. Namely, in FIG. 3, oxide layer 302, nitride layer 304, buried oxide (BOX) 306 and gate oxide (GOX) 308 are the dielectrics. Silicon-on-insulator (SOI) layer 310, polycrystalline silicon (PC) device 312 (i.e., gate contacts are made from polycrystalline silicon), contact via 314, metal level 1 (M1) 316 and substrate (SUB) 318 are conductors. As FIG. 3 illustrates, nitride layer 304 and gate oxide (GOX) layer 308 conform to device 312. Device 312 can comprise, for example, a transistor. Many different transistor configurations are possible. Such configurations are well known to those of skill in the art and thus are not described further herein. As will be described in detail below, the present techniques can be used to extract capacitances from wiring structures and integrated circuit designs having conformal three-dimensional dielectric media with multiple dielectrics, such as integrated circuit design 300.

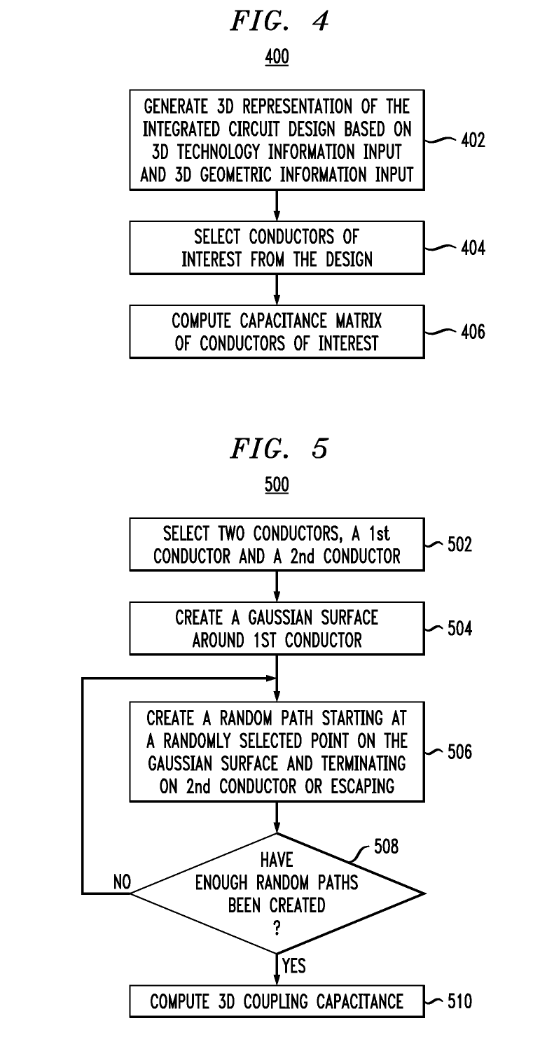

FIG. 4 is a diagram illustrating exemplary methodology 400 for determining capacitance between conductors in an integrated circuit design. In step 402, a three-dimensional (3D) representation of the design is generated based on three-dimensional geometric information input and three-dimensional technology information input. FIG. 3 (described above), for example, is a cross-sectional representation of exemplary integrated circuit design 300. The three-dimensional geometric information can include, for example, the various dimensions of the design, such as dimensions a-h in FIG. 3. The three-dimensional technology information can include information about three-dimensional conformal dielectrics. For example, in the case of conductors associated with a device (FIG. 3, for example), such information can include extent and value of spacer and spacer offset dielectrics on both sides of a gate of the device (e.g., shown generally in FIG. 3 as gate oxide (GOX) 308), as well as a conformal nitride dielectric (e.g., shown generally in FIG. 3 as nitride layer 304) on top of the gate and diffusion regions of the device. This extent should be given in both a mask plane and a vertical elevation of the device. In the case of conductors that are part of wiring structures, such information can include extent and values of dielectrics that are likely to sustain damage due to semiconductor metallization processes.

In step 404, conductors of interest are selected from the design. According to an exemplary embodiment, two conductors of interest are selected by selecting a conductor that is on a critical timing path of a logic signal in the integrated circuit. The second conductor would then be any other conductor that is coupled to the first conductor. It is advantageous to choose the second conductor as the conductor that is likely to have the most significant capacitive coupling to the first conductor, which can be accomplished by looking at geometric information such as the spacing between the first and second conductor. For instance, conductors that are close to each other will have a higher capacitive coupling than if the conductors were pulled apart from one another. According to another exemplary embodiment, two conductors of interest are selected by selecting those two conductors that have the greatest cross-talk, i.e., based on a preliminary signal integrity screening of the integrated circuit design. In step 406, three-dimensional coupling capacitance between the selected conductors is determined. Specifically, a capacitance matrix of the conductors selected in step 404, above, is computed. A capacitance matrix is a square, symmetric tableau of all of the coupling capacitances with diagonal entries in the tableau being self-capacitances of the conductors. A capacitance matrix is well known to those of skill in the art, and therefore is not described further herein. As will be described in detail below, a floating random walk technique is used in determining the capacitance.

The goal of methodology 400, and of the present teachings in general, is to extract three-dimensional coupling capacitance values for an integrated circuit design. That is why three-dimensional data is used in the calculations. Without three-dimensional data, the complete geometries of the design would not be fully attainable. See, for example, the teachings of Batterywala wherein vertical cross-sections are evaluated. Such two-dimensional sections would not provide enough information to analyze the complex geometries present in a device architecture.

Use of a floating random walk technique has several notable benefits. First, the floating random walk technique can be used to efficiently solve a very large number K of similar configurations in a time almost completely independent of the number of configurations K. Second, the complexity of the floating random walk technique is independent of the number of conductors in a design and thus can enable efficient handling of large, very complex conductor systems. Third, the floating random walk technique is extremely efficient in terms of memory utilization since it does not involve matrix assembly or system solves. Fourth, the floating random walk technique offers the ability to report intermediate results with error bounds, which enables the design of stopping criteria that are in line with the required accuracy of the extraction case at hand. Fifth, the floating random walk technique is very amenable to parallelization and can therefore utilize current advances in multithreaded, multicore computer architectures. In the present teachings, the floating random walk technique is configured to efficiently handle three-dimensional multilayered dielectric configurations.

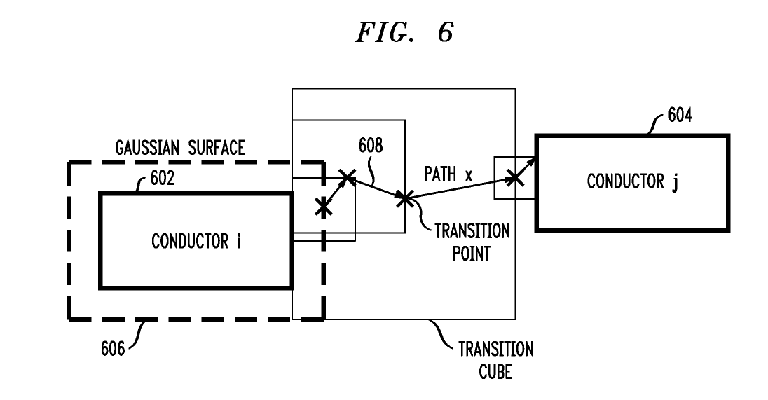

FIG. 5 is a diagram illustrating exemplary methodology 500 for using a floating random walk technique to determine the capacitance between two conductors, i.e., a first conductor and a second conductor. In step 502, two conductors are selected. By way of example only, these two conductors may be a sub-selection of the conductors of interest selected above (see step 404 of methodology 400). In step 504, a Gaussian surface is created around one of the conductors. The process can begin at either conductor, for example in FIG. 5 the Gaussian surface is created around the first conductor. In step 506, a floating random walk path is created starting at a randomly selected point on the Gaussian surface and terminating on the second conductor, or escaping. As will be described in detail below, the floating random walk path is created using one or more (e.g., a series of) maximal bounding cubes. Such a process for creating a floating random walk path is depicted schematically in FIG. 6. In step 508, an evaluation is made as to whether enough random paths have been created. Whether or not enough random paths have been created is dependent on the level of accuracy desired. Namely, since the floating random walk technique involves the use of probability density functions (see below), the greater the number of paths, the greater the level of accuracy. The level of accuracy can be pre-set by a user before running methodology 500.

If more random paths are needed, then step 506 is repeated until the capacitance between the conductors can be extracted. However, if enough random paths have been created, then in step 510, the random path (or paths, if multiple paths are created) is used to compute three-dimensional coupling capacitance between the first and second conductors. Being able to compute three-dimensional coupling capacitance is important because three-dimensional coupling capacitances accurately account for, e.g., electrostatic couplings between conductors with short run lengths as in wire endings, jogs and pads. These structures are well known to those of skill in the art of capacitance calculation. Furthermore, it is well known to those of skill in the art that orthogonal wire crossings, which are very common in high-performance integrated circuits, are best accounted for with three-dimensional capacitances. In the device context, it is well known that three-dimensional capacitances are needed to account for couplings between gate poly-silicon and vias connecting diffusion regions to interconnect on the first wiring layer. The process for computing three-dimensional coupling capacitance is described in further detail below.

FIG. 6 is a diagram illustrating an exemplary floating random walk path x. FIG. 6 is a schematic depiction of a floating random walk path that might be generated between two conductors using methodology 500, see above. In FIG. 6, two conductors 602 and 604 labeled “conductor i” and “conductor j,” respectively, are representative, for example, of the first and second conductors used in methodology 500, see above. A Gaussian surface 606 has been created around conductor i. A series of maximal bounding cubes labeled “transition cube” and points labeled “transition point” are used to create random walk path 608 labeled “Path x” between conductor i and conductor j.

The floating random walk technique is based on expressing the capacitance Cᵢⱼ between conductor i and conductor j as a multidimensional (possibly infinite dimensional) integral of the prescribed conductor potentials. When extracting Cᵢⱼ , conductor j is assumed at unit potential, while all the other conductors are at zero potential. The formulation starts with expressing the capacitance Cᵢⱼ, or equivalently the total charge qᵢ at conductor i, as a function of the electric field \vec{E}(r):

$$\begin{matrix}{C}_{ij} = {q}_{i} \vert ( {φ}_{j} = 1 ) \\ = {\int }_{{S}_{0} } \vec{E} ( {η}^{( 0 )} ) \cdot \hat{n} d {η}^{( 0 )} \\ = {\int }_{{S}_{0}}^{ } - ∇ φ ( {η}^{( 0 )} ) \cdot \hat{n} d {η}^{( 0 )} ,\end{matrix} \qquad ( 1 )$$

wherein S₀ is a Gaussian surface surrounding conductor i, \hat{n} is the corresponding normal and φ(η⁽⁰⁾) is the electrostatic potential. The idea is to use Green's function to write the potential φ(η⁽⁰⁾) as a flnction of the potential of a surrounding boundary. This boundary is arbitrary provided the domain is homogeneous (the homogeneity constraint may be relaxed so that multilayered media can be handled efficiently, see below). In the basic form of the floating random walk technique, the potential of a point η⁽⁰⁾is written in terms of the potential at the boundary of the largest bounding cube S₁ centered around η⁽⁰⁾ and extending to the edge of (i.e., touching) the nearest conductor (but not including any conductor(s)). Thus, the potential is given by:

$$φ ( {η}^{( 0 )} ) = {\int }_{{S}_{1}}^{ } G ( {η}^{( 0 )} , {η}^{( 1 )} ) φ ( {η}^{( 1 )} ) d {η}^{( 1 )} , \qquad ( 2 )$$

wherein G(η⁽⁰⁾,η⁽¹⁾) is the Green's function associated with the Laplace equation in the cube S₁ domain. One of the main ideas behind the floating random walk technique is the interpretation of G(η⁽⁰⁾,η⁽¹⁾) as a probability density function. This follows directly from the maximum principle of harmonic functions and from the uniqueness of the solution theorem, since if the entire boundary has unit potential then the solution of the Laplace equation within the entire cube domain is also a constant unit potential, i.e.,

$$1 = {\int }_{{S}_{1}}^{ } G ( {η}^{( 0 )} , {η}^{( 1 )} ) d {η}^{( 1 )} .$$

With this probabilistic interpretation, the Green's function of a given transition cube can be identified with a transition probability that measures the likelihood of a point η⁽⁰⁾ inside of the cube to be connected with a point η⁽¹⁾ on the boundary. Throughout the description, the terminology of a “transition probability” will be used interchangeably with a Green's function.

It is notable that by construction, part of the boundary of the bounding cube is touching at least part of some conductor boundary and therefore has a prescribed potential. Therefore, Equation 2, above, can be re-written as:

$$φ ( {η}^{( 0 )} ) = {\int }_{{K}_{1}}^{ } G ( {η}^{( 0 )} , {η}^{( 1 )} ) φ ( {η}^{( 1 )} ) d {η}^{( 1 )} ++ {\int }_{{U}_{1}}^{ } G ( {η}^{( 0 )} , {η}^{( 1 )} ) φ ( {η}^{( 1 )} ) d {η}^{( 1 )} , \qquad ( 3 )$$

wherein K₁ is the part of the boundary with the specified potential, whereas U₁ is the part of the boundary not touching any conductor and therefore its potential is unspecified and yet to be determined. The unknown potential associated with a point on U₁ is then rewritten in terms of the potential over another bounding cube constructed as explained above. This process is then repeated recursively to result in the following expansion:

$$φ ( {η}^{( 0 )} ) = {\int }_{{K}_{1}}^{ } d {η}^{( 1 )} G ( {η}^{( 0 )} , {η}^{( 1 )} ) φ ( {η}^{( 1 )} ) ++ {\int }_{{U}_{1}}^{ } d {η}^{( 1 )} G ( {η}^{( 0 )} , {η}^{( 1 )} ) {\int }_{{K}_{2}}^{ } d {η}^{( 2 )} G ( {η}^{( 1 )} , {η}^{( 2 )} ) φ ( {η}^{( 2 )} ) + … + {\int }_{{U}_{1}}^{ } d {η}^{( 1 )} G ( {η}^{( 0 )} , {η}^{( 1 )} ) {\int }_{{U}_{2}}^{ } d {η}^{( 2 )} G ( {η}^{( 1 )} , {η}^{( 2 )} ) \times \times … {\int }_{{K}_{m}}^{ } d {η}^{( m )} G ( {η}^{( m - 1 )} , {η}^{( m )} ) φ ( {η}^{( m )} ) . \qquad ( 4 )$$

The following notation is used to describe the multidimensional integral: Sᵢ=Kᵢ∪Uᵢ, wherein Kᵢ and Uᵢ are the parts of surface Sᵢ with known and unknown potentials, respectively. The resulting multidimensional integral is then computed using Monte Carlo integration which is then interpreted as a random walk. Each random walk is made up of a sequence of random steps. The random walk stops when the random step falls within a distance ε from a conductor boundary. Consequently, the capacitance formula, i.e., Equation 4, above, is discretized within the floating random walk implementation as follows:

$$\begin{matrix}{C}_{ij} = {q}_{i} {\vert}_{( {φ}_{j} = 1 )} \\ = {\sum }_{{i}_{0} = 1}^{{N}_{0}} {Δ}_{{i}_{0}} {\sum }_{{i}_{1} = 1}^{{N}_{1}} {∇}_{n} G ( {η}_{{i}_{0}}^{( 0 )} , {η}_{{i}_{1}}^{( 1 )} ) {Δ}_{{i}_{1}} {φ}_{j} ++ \\ {\sum }_{{i}_{0} = 1}^{{N}_{0}} {Δ}_{{i}_{0}} {\sum }_{{i}_{1} = 1}^{{N}_{1}} {∇}_{n} G ( {η}_{{i}_{0}}^{( 0 )} , {η}_{{i}_{1}}^{( 1 )} ) {Δ}_{{i}_{1}} {\sum }_{{i}_{2} = 1}^{{N}_{2}} G ( {η}_{{i}_{1}}^{( 1 )} , {η}_{{i}_{2}}^{( 2 )} ) {Δ}_{{i}_{2}} {φ}_{j} ++ \\ {\sum }_{{i}_{0} = 1}^{{N}_{0}} {Δ}_{{i}_{0}} {\sum }_{{i}_{1} = 1}^{{N}_{1}} {∇}_{n} G ( {η}_{{i}_{0}}^{( 0 )} , {η}_{{i}_{1}}^{( 1 )} ) {Δ}_{{i}_{1}} \times \times \\ {\sum }_{{i}_{2} = 1}^{{N}_{2}} G ( {η}_{{i}_{1}}^{( 1 )} , {η}_{{i}_{2}}^{( 2 )} ) {Δ}_{{i}_{2}} … {\sum }_{{i}_{m} = 1}^{{N}_{m}} G ( {η}_{{i}_{m - 1}}^{( m - 1 )} , {η}_{{i}_{m}}^{( m )} ) {Δ}_{{i}_{m}} {φ}_{j} ,\end{matrix} \qquad ( 5 )$$

wherein Δᵢ_{ₘ} is the iₘ^{th} incremental distance on surface m. Note that when extracting Cᵢⱼ , all conductors except the j^{th} conductor are assumed grounded. Consequently, one can extract in parallel all Cᵢₓ:x ∈{1, 2, . . . , N}, wherein N is the total number of conductors.

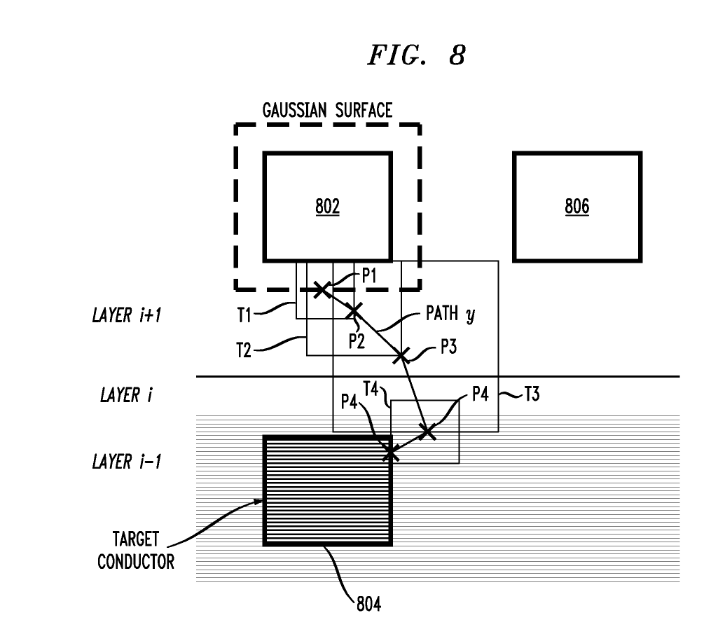

The floating random walk technique can handle arbitrary multilayered media. As is shown, for example, in FIG. 8 (described below), multilayered media is commonly found between conductors in an integrated circuit design and typically comprises arbitrary layers of dielectric materials of various shapes and dielectric constants.

With conventional floating random walk approaches, the boundaries between the dielectric layers are generally treated as constraints on the step size and consequently as acceptable stopping points for a random walk path. Thus, the difference between a conductor edge and a dielectric interface is that the random walk is restarted if it terminates at a dielectric interface. The restarts are repeated until the walk terminates at a conductor edge. However, with current technologies having complex layered configurations and small dielectric layer thicknesses, such a random walk with restarts becomes very time consuming. A more efficient alternative approach to restarting the random walk was derived for simple dielectric configurations in J. N. Jere et al., “An Improved Floating-Random-Walk Algorithm for Solving the Multi-Dielectric Dirichlet Problem,” IEEE Transactions on Microwave Theory and Techniques, vol. 41, no. 2 (February 1993) (hereinafter “Jere”). The work in Jere is a precursor to Batterywala as Jere relies on pre-computing the Green's functions offline using a stochastic technique. Such Green's functions are tabulated and called within the random walk to compute the transition probabilities G(η⁽ⁱ⁾,η⁽ⁱ⁺¹⁾) at step i+1. Unfortunately, this approach is limited to a small number of dielectrics and is hard to generalize since it requires the pre-computation and tabulation of all possible Green's functions necessary to complete the random walk. Furthermore, this approach does not seem to exploit the possibility of computing the layered Green's function using a deterministic approach, nor does it benefit from the distinct advantages of computing the layered Green's function online rather than offline.

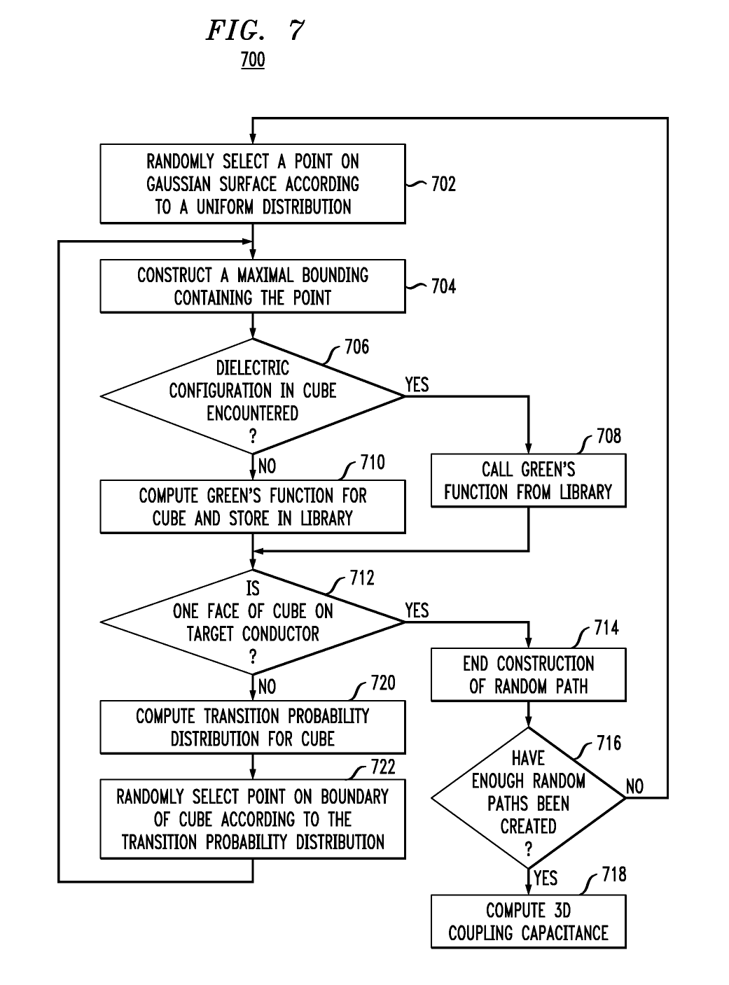

According to the present teachings, in order to adapt the floating random walk technique to handle arbitrary multilayered material, dielectric interfaces are ignored so that the transition cubes are constrained only by the surrounding metals (conductors). FIG. 7 is a diagram illustrating exemplary methodology 700 for using a floating random walk technique to determine the capacitance between two conductors, i.e., a first (starting) conductor and a second (target) conductor, separated from one another by arbitrary multilayered dielectric media. In step 702, a point P(1) is randomly selected on a Gaussian surface surrounding one of the conductors (see above) arbitrarily referred to herein as the first conductor. On the Gaussian surface, all of the points are considered equally likely and so the point P(1) is selected according to a uniform distribution. In step 704, a maximal bounding cube T(i) is constructed containing the point P(1). Cube T(i) may be constructed so as to be centered at the point P(1). However, with the present finite-difference based techniques, centering the cube on the transition point is not necessary, as long as the cube contains the transition point. See description below. As above, the bounding cube is constructed so as to extend to the edge of the nearest conductor but not to include a conductor.

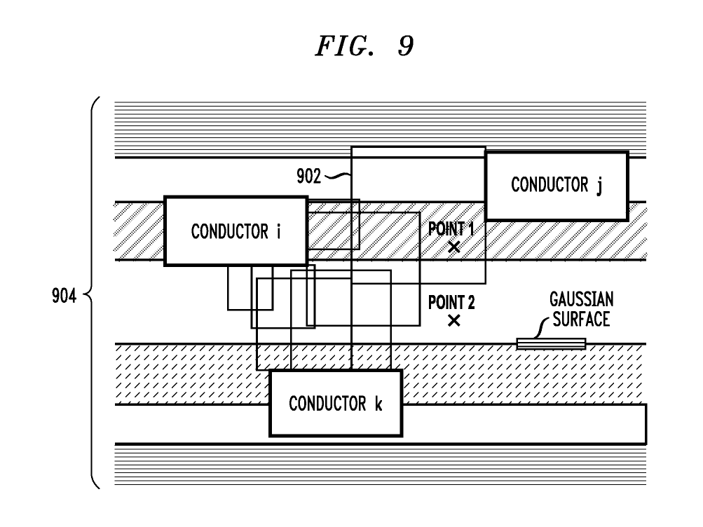

It is assumed for this example that the bounding cube will include some dielectric media configuration, for example, either a single dielectric media or a multilayered dielectric media. In step 706, a determination is made as to whether or not the dielectric configuration in the cube T(i) has been previously encountered. Specifically, the present techniques utilize information from previous similar solves in a smart way such that the solution time for subsequent configurations is reduced. Thus, as will be described in detail below, whenever a new dielectric configuration (one that has not be encountered before) is encountered, the computed Green's function will be saved (in a databank, i.e., a library) for future use, should the same configuration arise again. As such, if the dielectric configuration in the cube has been encountered before, then in step 708 the Green's function for that configuration is sourced from the library. On the other hand, if the dielectric configuration in the cube has not been encountered before, then in step 710 the Green's function for the cube T(i) is computed and stored in the library. According to an exemplary embodiment, a finite-difference technique is used to compute the Green's function. Thus, the present techniques can be performed online, rather than relying on pre-computed functions as in the above-described conventional techniques. These steps for obtaining the Green's function for bounding cubes when arbitrary multilayered dielectric media is involved are described further with reference to the description of FIG. 9, below.

In step 712, another determination is made as to whether or not one face of the cube T(i) is touching the target conductor, arbitrarily referred to herein as the second conductor. If one face of the cube T(i) is touching the target conductor, then in step 714 construction of that particular random path is ended.

A determination is then made in step 716 as to whether or not enough random paths have been created. As described above, the number of random paths is proportional to the level of accuracy needed or desired. If enough random paths have been created, then in step 718 the three-dimensional coupling capacitance is calculated. An exemplary capacitance formula for arbitrary multilayered dielectric media is provided below. Alternatively, if the present accuracy level requires that more random paths be created, then the steps of methodology 700 can be repeated beginning, for example, with another randomly selected point P(2) on the Gaussian surface.

On the other hand, if the cube T(i) is not touching the target conductor, then the random walk path has to be continued to reach the target conductor. Thus, in step 720 a transition probability distribution for the cube T(i) is computed using the Green's function. According to an exemplary embodiment, the transition probability distribution for the cube T(i) is computed by computing the full transition probability of every point within an interior of the cube. In step 722, a point P(i) is randomly selected on the boundary of the cube T(i). Unlike the Gaussian surface case where the random selection is done according to a uniform probability distribution (see above), with a transition cube the random selection is done according to the Green's probability density function computed using the Green's function. Such density function gives the likelihood that a point on the boundary of the cube is reachable from a point in the interior of the cube. The steps of methodology 700 beginning at step 704 can then be repeated to construct a series of cubes T(i+1), T(i+2), . . . each cube containing (and may or may not be centered on) a randomly selected point on a boundary of an immediately preceding cube in the series (e.g., cube T(i+1) will contain a randomly selected point on a boundary of cube T(i), and so on) until one face of a given cube along the random walk path touches the target conductor. Each cube in the series will extend to the edge of the nearest conductor but will not include a conductor.

An exemplary capacitance formula for arbitrary multilayered dielectric media that can be implemented with the present techniques is as follows:

$${C}_{12} = - {\sum }_{i 1 = 1}^{{Nq}_{1}} {Δ}_{i 1} {\sum }_{i 2 = 1}^{{Nq}_{2}} {Δ}_{i 2} {∇}_{n} G ( {r}_{i 1} , {r}_{i 2} ) {\sum }_{i 3 = 1}^{{Nq}_{3}} {Δ}_{i 3} G ( {r}_{i 2} , {r}_{i 3} ) … {\sum }_{im = 1}^{{Nq}_{m}} {Δ}_{im} G ( {r}_{im - 1} , {r}_{im} ) {V}_{{r}_{im}} . \qquad ( 6 )$$

In Equation 6, C₁₂ represents the coupling capacitance between a first and a second conductor, i.e., between conductors 1 and 2. G(rᵢ₁, rᵢ₂) represents the Green's function of a first bounding cube (by way of example only, cube T(i) in methodology 700, above), wherein rᵢ₁ represents a center point of the first cube and rᵢ₂ represents a boundary point of the first cube. G(rᵢ₂,rᵢ₃) represents the Green's function of a second bounding cube in the series (by way of example only cube T(i+1) when methodology 700 is repeated until one face of a given cube along the random walk path touches the target conductor). Similarly, G(rᵢₘ₋₁,rᵢₘ) represents the Green's function of an m-th and final cube along the random walk path.

$${\sum }_{im = 1}^{{Nq}_{m}} {Δ}_{im} G ( {r}_{im - 1} , {r}_{im} )$$

is the boundary integration step for the m-th cube and Vᵣ_{ᵢₘ} is the assigned potential on the second, target conductor.

FIG. 8 is a diagram illustrating an exemplary floating random walk path y. FIG. 8 is a schematic depiction of a random walk path that might be generated between two conductors using methodology 700, see above. In FIG. 8, two conductors 802 and 804 are representative, for example, of the first and second (target) conductors used in methodology 700, see above. A third conductor 806 is also shown but is not part of the floating random walk path. Floating random walk path y begins at a randomly selected point P1 on a Gaussian surface surrounding conductor 802. A maximal bounding cube T1 is shown containing point P1. Notice that bounding cube T1 has been constructed so as to extend to the edge of the nearest conductor, i.e., conductor 802, but not to include a conductor. Since cube T1 is not touching conductor 804, the target conductor, one or more other bounding cubes are needed. Specifically, a point P2 is randomly selected on the boundary of cube T1. A maximal bounding cube T2 is shown containing point P2. Cubes T1 and T2 are both within a single dielectric layer i+1 and thus include only a single dielectric media.

A point P3 is randomly selected on the boundary of cube T2. A maximal bounding cube T3 is shown containing point P3. By contrast with cubes T1 and T2, cube T3 transcends three dielectric layers, layer i+1, layer i and layer i−1 and thus includes a multilayered dielectric media configuration.

A point P4 is randomly selected on the boundary of cube T3. A maximal bounding cube T4 is shown containing point P4. Cube T4 transcends dielectric layers i and i−1 and thus also includes a multilayered dielectric media configuration. As highlighted above, the Green's functions for each of the cubes can either be retrieved from a library of stored finctions, if available, or otherwise computed using a finite-difference technique.

In order to model structures in nonhomogeneous media (described by arbitrary dielectric profile), the present techniques rely on ignoring dielectric interfaces so that the transition cubes are constrained only by the surrounding metals (conductors). However, since the media inside of any given one of the cubes may not be homogeneous, a closed form expression for the Green's function of that cube cannot be known. To overcome this difficulty a numerical technique is used to solve a small subproblem from which the transition probability can be obtained. The subproblem domain is bounded by the transition cube and contains the nonhomogeneous medium of interest. The objective is to find the potential in the interior of the bounding cube as a function of an unknown boundary potential φ_{B}. A finite difference scheme is used to solve this problem, which results in a linear system of the form:

$$( \begin{matrix}{M}_{11} & {M}_{12} \\ 0 & 1\end{matrix} ) ( \begin{matrix}{φ}_{1} \\ {φ}_{2}\end{matrix} ) = ( \begin{matrix}0 \\ {φ}_{B}\end{matrix} ) , \qquad ( 7 )$$

wherein φ₁ is a potential of interior points of the cube, φ₂ is a potential of boundary points of the cube, M₁₁ is the five diagonal block of the system matrix representing interactions not involving boundary elements and is therefore of size (Nₓ−2)(N_{y}−2)×(Nₓ−2)(N_{y}−2), wherein Nₓ and N_{y} are the total number of grid points (including the boundary points) in the x and y directions, respectively. M₁₂ is a matrix of size (Nₓ−2)(N_{y}−2)×(2Nₓ−2N_{y}) containing mutual interactions between interior and boundary points and is mostly zero since only rows and colunmns immediately neighboring boundary points are contributing to such interaction. This system of equations can be reduced by eliminating the unknown potential φ₂ to obtain:

φ₁=−(M₁₁)⁻¹ M_{12φB}. (8)

It is straightforward to prove that the row vector containing the elements of the discretized Green's function,

[G(η⁽ⁱ⁾,η₁⁽ⁱ⁺¹⁾)Δ₁,G(η⁽ⁱ⁾,η₂⁽ⁱ⁺¹⁾)Δ₂, . . . , G(η⁽ⁱ⁾,η_{2N}_{ₓ}_{+2N}_{_{y}}⁽ⁱ⁺¹⁾)Δ_{2N}_{ₓ}_{+2N}_{_{y}}], (9)

wherein η⁽ⁱ⁾ is the location of a point inside of the transition cube and ηₖ⁽ⁱ⁺¹⁾ and Δₖ are a center point and a length, respectively, of the k^{th} discretization of the transition cube boundary, is defined as the γ^{th} row of the matrix −(M₁₁)⁻¹ M₁₂, wherein γ is the index of the point η⁽ⁱ⁾ within the transition square.

The Green's finction obtained from Equation 8 is a discrete probability density function and therefore can be used to compute the transition probability. The Green's function defines the relation between the potential in the interior and that on the boundary. To prove that the Green's function is also a probability density function it is shown that the following two conditions exist:

1) ones((Nₓ−2)(N_{y}−2))=−(M₁₁)⁻¹ M₁₂ones(2Nₓ+2N_{y}), wherein ones(n) is a row vector of size n×1 and every element of the vector is equal to 1; and

2) [−(M₁₁)⁻¹ M₁₂](i,j) ∈[0,1]:∀i,j.

Condition 1 is apparent from the uniqueness of solution and the fact that, independent of the dielectric profile, if the boundary potential is set to a constant equal to one (i.e., φ_{B} is a vector of all ones) then the solution φ₁ (potential inside of the interior) is a constant equal to one everywhere.

Condition 2 follows from the maximum (minimum) principle for harmonic functions. There is a point of caution, since the domain is not homogeneous the function can attain its maximum (minimum) anywhere on the boundary of the subdomains which includes the interfaces between the dielectric layers. However, the following description proves that this is impossible under the existing boundary conditions.

First, assume that the external boundary has only unit and zero boundary conditions (i.e., φ_{B}=v:v ∈{0,1}). Next, assume that some point on the dielectric interface has a value greater than one (less than zero). It thus follows that there is a maximum (minimum) potential at some point on the interface. At such a point the normal components of the displacement vector \vec{D} are directed away from (towards) the interface. From the boundary conditions there must be a net surface charge as follows directly from applying Gauss' law at the boundary (see, for example FIG. 9, described below). However, this is impossible since there is no net charge at dielectric interfaces. Consequently, the maximum or minimum is not on the interface and the potential of any interior point is ∈[0,1].

Unfortunately, the above-described process can be slow since the time required to solve the subproblem is significantly larger than the time required for any other operation within a random walk step. To avoid such computational disadvantage the observation is made that the transition cube does not need to be centered around the transition point. In fact any point contained within the cube can be written in terms of the potential of the boundary of the transition square. However, since the transition cubes are only determined by the geometry, which is fixed at every step for every walk, the computational domain can be fully covered by a small number of unique transition cubes. These cubes constitute a finite set of transition cubes for which a finite difference solve (Equation 8) is required. The solution of Equation 8 (namely, −(M₁₁)⁻¹ M₁₂) provides the transition probability for every point within the corresponding cube.

FIG. 9 is a diagram illustrating pre-computed transition cubes 902 in a multilayered dielectric media 904. Transition cubes 902 are a representative subset of the pre-computed transition probabilities for dielectric configurations that are stored in the library. See, for example, steps 706-710 of methodology 700, described above. In the exemplary integrated circuit configuration shown in FIG. 9 there are three conductors labeled “conductor i,” “conductor j” and “conductor k.” Two transition points are shown labeled “point 1” and “point 2.” Point 1 falls within one of the pre-computed transition cubes 902, while point 2 does not. Thus, a transition probability density will only have to be computed for point 2

It should be emphasized that since the geometry can be covered by a small number of cubes (see, for example, FIG. 9) satisfying the construction criteria, the number of total finite difference solves is very small compared to the total number of runs required to extract the complete capacitance matrix. Consequently, the present floating random walk techniques do not alter the average computation time per random walk step, even if the techniques significantly increase such time for the first few steps. Moreover, the required memory to store the transition probabilities is insignificant. Finally, if the technology file is available beforehand, such transition probabilities can be pre-computed offline and used within the floating random walk.

The effectiveness of the present techniques is further illustrated through the following non-limiting example. Specifically, implementation results are demonstrated of the numerically obtained Green's function, and the effect of using a non-centered Green's function on the speed of convergence of the floating random walk technique. The multilayered stack used was composed of a substrate with dielectric constant ε=11.9, and 10 successive layers of dielectric constants ranging from 2.2 to 4.4, and finally a half space of free space. The stack was simulated using both a standard floating random walk technique and the present modified finite-difference based floating random walk technique described above. It was observed that using the present Green's function the average path length is reduced from 19 to six steps, consequently, the simulation time is reduced by a factor of three. It is further observed that the number of unique Green's function computations is on the order of 1,000, which is very small compared to the total number of random walks (≅10⁵). This in turn explains why the average step cost remains approximately the same.

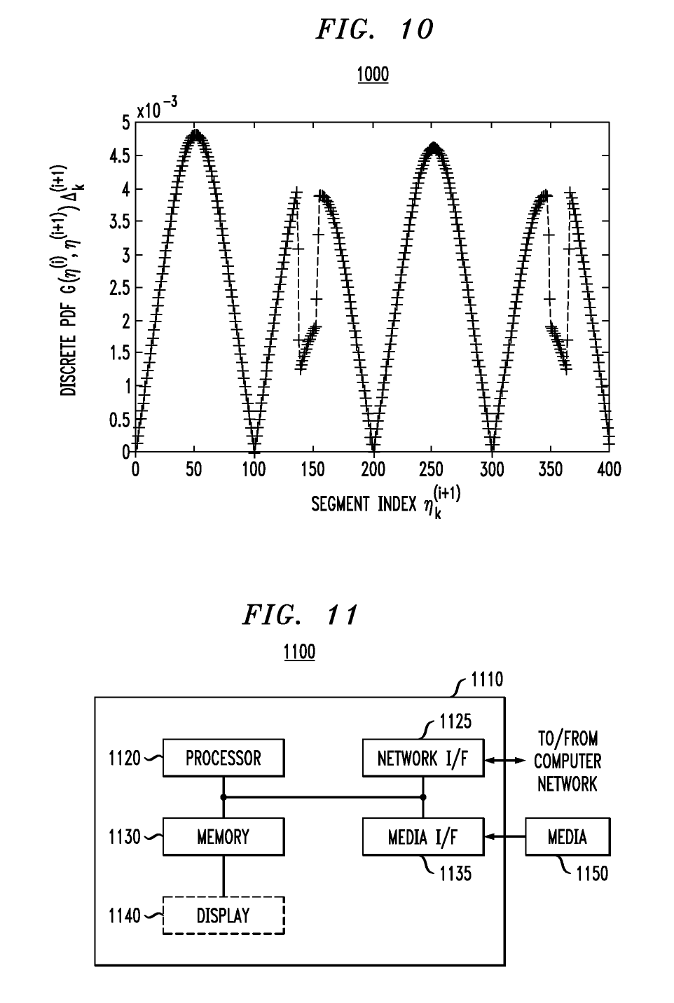

FIG. 10 is a graph 1000 illustrating a sample Green's function computed for a portion of the dielectric stack. Specifically, graph 1000 depicts the numerically computed Green's function G(η⁽ⁱ⁾,η⁽ⁱ⁺¹⁾), wherein η⁽ⁱ⁺¹⁾ is the variable parameterizing the contour of a transition cube of side length h. The contour is traveled on the contour clockwise direction starting from the lower horizontal side. The discontinuities around segment indices 150 and 350 correspond to the thin central layer with lower dielectric constant. The total integral of the Green's function is 1,000 (accurate to the 8^{th} digit). In graph 1000, the segment index ηₖ⁽ⁱ⁺¹⁾ is plotted on the x-axis and the discrete probability density function (PDF) G(η⁽ⁱ⁾,η⁽ⁱ⁺¹⁾)Δₖ⁽ⁱ⁺¹⁾ is plotted on the y-axis.

Turning now to FIG. 11, a block diagram is shown of an apparatus 1100 for determining coupling capacitance between conductors within an integrated circuit design, in accordance with one embodiment of the present invention. It should be understood that apparatus 1100 represents one embodiment for implementing methodology 400 (FIG. 4), methodology 500 (FIG. 5) and/or methodology 700 (FIG. 7).

Apparatus 1100 comprises a computer system 1110 and removable media 1150. Computer system 1110 comprises a processor 1120, a network interface 1125, a memory 1130, a media interface 1135 and an optional display 1140. Network interface 1125 allows computer system 1110 to connect to a network, while media interface 1135 allows computer system 1110 to interact with media, such as a hard drive or removable media 1150.

As is known in the art, the methods and apparatus discussed herein may be distributed as an article of manufacture that itself comprises a machine-readable medium containing one or more programs which when executed implement embodiments of the present invention. For instance, the machine-readable medium may contain a program configured to generate a three-dimensional representation of the integrated circuit design based on three-dimensional technology input and three-dimensional geometric input about the integrated circuit; select conductors of interest from the design; and determine three-dimensional coupling capacitance between the selected conductors. The program may be further configured to select a first conductor and a second conductor from the conductors of interest; create a Gaussian surface around the first conductor; create a random walk path starting at a randomly selected point on the Gaussian surface and terminating on the second conductor; and use the random walk path to compute the three-dimensional coupling capacitance between the first and second conductors.

The first conductor and the second conductor can be separated from one another by dielectric media at least a portion of which is multilayered. In that case, the program may be further configured to construct a maximal bounding cube to contain the randomly selected point on the Gaussian surface and to extend to the edge of the nearest conductor, the maximal bounding cube including at least a portion of the dielectric media; and obtain a Green's function for a configuration of the dielectric media within the bounding cube.

The machine-readable medium may be a recordable medium (e.g., floppy disks, hard drive, optical disks such as removable media 1150, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used.

Processor 1120 can be configured to implement the methods, steps, and functions disclosed herein. The memory 1130 could be distributed or local and the processor 1120 could be distributed or singular. The memory 1130 could be implemented as an electrical, magnetic or optical memory, or any combination of these or other types of storage devices. Moreover, the term “memory” should be construed broadly enough to encompass any information able to be read from, or written to, an address in the addressable space accessed by processor 1120. With this definition, information on a network, accessible through network interface 1125, is still within memory 1130 because the processor 1120 can retrieve the information from the network. It should be noted that each distributed processor that makes up processor 1120 generally contains its own addressable memory space. It should also be noted that some or all of computer system 1110 can be incorporated into an application-specific or general-use integrated circuit.

Optional video display 1140 is any type of video display suitable for interacting with a human user of apparatus 1100. Generally, video display 1140 is a computer monitor or other similar video display.

In conclusion, provide herein are enhanced floating random walk techniques that are of immediate relevance to variation-aware and lithography-driven layout parasitic extraction flows, which can be used to efficiently compute the capacitance of conductors in nonhomogeneous media using a finite-difference method that is general enough to handle any dielectric configuration. For example, the present floating random walk technique results in an average decrease in the simulation time by a factor of three, as compared with standard floating random walk processes.

A notable advantage of the present techniques is that the average time required to solve a single configuration within a set of similar configurations is reduced as the cardinality of the set is increased. It has been observed that the average simulation time of a single configuration of a set of similar configurations of cardinality 105 is reduced by three orders of magnitude. Consequently, more than 130,000 similar configurations can be solved in the time required to solve just 50 independent configurations. Such a favorable result will naturally fit in a litho- and CMP-aware extraction flow.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A method for determining coupling capacitance between conductors within an integrated circuit design, the method comprising the steps of:
generating a three-dimensional representation of the integrated circuit design based on three-dimensional technology input and three-dimensional geometric input about the integrated circuit;
selecting conductors of interest from the design; and
determining three-dimensional coupling capacitance between the selected conductors.

2. The method of claim 1, further comprising the steps of:
selecting a first conductor and a second conductor from the conductors of interest;
creating a Gaussian surface around the first conductor;
creating a random walk path starting at a randomly selected point on the Gaussian surface and terminating on the second conductor; and
using the random walk path to compute the three-dimensional coupling capacitance between the first and second conductors.

3. The method of claim 2, further comprising the steps of:
setting a level of accuracy for the capacitance determination; and
evaluating whether enough random walk paths have been created to attain the level of accuracy.

4. The method of claim 3, further comprising the step of:
repeating the step of creating a random walk path until enough random walk paths have been created to attain the level of accuracy for the capacitance determination.

5. The method of claim 2, wherein the first conductor and the second conductor are separated from one another by dielectric media at least a portion of which is multilayered, the method further comprising the steps of:
constructing a maximal bounding cube to contain the randomly selected point on the Gaussian surface and to extend to the edge of the nearest conductor, the maximal bounding cube including at least a portion of the dielectric media; and
obtaining a Green's finction for a configuration of the dielectric media within the bounding cube.

6. The method of claim 5, further comprising the step of:
ending the random walk path if the bounding cube is touching the second conductor.

7. The method of claim 5, further comprising the step of:
creating a series of maximal bounding cubes, each of which contains a randomly selected point on a boundary of an immediately preceding bounding cube in the series and extends to an edge of the nearest conductor, each maximal bounding cube including at least a portion of the dielectric media;
obtaining a Green's function for a configuration of the dielectric media within each of the bounding cubes in the series; and
ending the random walk path when a bounding cubes in the series is created that touches the second conductor.

8. The method of claim 5, further comprising the step of:
constructing the maximal bounding cube to be centered at the randomly selected point on the Gaussian surface.

9. The method of claim 2, further comprising the step of:
constructing each maximal bounding cube in the series to be centered at the randomly selected point on the boundary of the immediately preceding bounding cube in the series.

10. The method of claim 5, wherein the step of obtaining the Green's function for the configuration of the dielectric media within the bounding cube further comprises the step of:
evaluating whether the configuration of the dielectric media within the bounding cube has been previously encountered and is stored in a databank; and
sourcing the Green's function for the configuration of the dielectric media from the databank if the configuration of the dielectric media within the bounding cube has been previously encountered.

11. The method of claim 5, wherein the step of obtaining the Green's function for the configuration of the dielectric media within the bounding cube further comprises the step of:
evaluating whether the configuration of the dielectric media within the bounding cube has been previously encountered and is stored in a databank;
computing the Green's function for the configuration of the dielectric media from the databank if the configuration of the dielectric media within the bounding cube has not been previously encountered; and
storing the computed Green's function in the databank.

12. The method of claim 11, further comprising the step of:
computing the Green's function for the configuration of the dielectric media from the databank, using a finite-difference technique, if the configuration of the dielectric media within the bounding cube has not been previously encountered 13. An apparatus for determining coupling capacitance between conductors within an integrated circuit design, the apparatus comprising:
a memory; and
at least one processor, coupled to the memory, operative to:
generate a three-dimensional representation of the integrated circuit design based on three-dimensional technology input and three-dimensional geometric input about the integrated circuit;
select conductors of interest from the design; and
determine three-dimensional coupling capacitance between the selected conductors.

14. The apparatus of claim 13, wherein the at least one processor is further operative to:
select a first conductor and a second conductor from the conductors of interest;
create a Gaussian surface around the first conductor;
create a random walk path starting at a randomly selected point on the Gaussian surface and terminating on the second conductor; and
use the random walk path to compute the three-dimensional coupling capacitance between the first and second conductors.

15. The apparatus of claim 14, wherein the first conductor and the second conductor are separated from one another by dielectric media at least a portion of which is multilayered, and wherein the at least one processor is further operative to:
construct a maximal bounding cube to contain the randomly selected point on the Gaussian surface and to extend to the edge of the nearest conductor, the maximal bounding cube including at least a portion of the dielectric media;
obtain a Green's function for a configuration of the dielectric media within the bounding cube.

16. An article of manufacture for determining coupling capacitance between conductors within an integrated circuit design, comprising a machine-readable medium containing one or more programs which when executed implement the steps of:
generating a three-dimensional representation of the integrated circuit design based on three-dimensional technology input and three-dimensional geometric input about the integrated circuit;
selecting conductors of interest from the design; and
determining three-dimensional coupling capacitance between the selected conductors.

17. The article of manufacture of claim 16, wherein the one or more programs which when executed further implement the steps of:
selecting a first conductor and a second conductor from the conductors of interest;
creating a Gaussian surface around the first conductor;
creating a random walk path starting at a randomly selected point on the Gaussian surface and terminating on the second conductor; and
using the random walk path to compute the three-dimensional coupling capacitance between the first and second conductors.

18. The article of manufacture of claim 17, wherein the first conductor and the second conductor are separated from one another by dielectric media at least a portion of which is multilayered, and wherein the one or more programs which when executed further implement the steps of:
constructing a maximal bounding cube to contain the randomly selected point on the Gaussian surface and to extend to the edge of the nearest conductor, the maximal bounding cube including at least a portion of the dielectric media;
obtaining a Green's function for a configuration of the dielectric media within the bounding cube.
